(19) United States
(12) Patent Application Publication
(10) Pub. No.: US 2013/0281143 A1
(43) Pub. Date: Oct. 24, 2013

(54) METHOD AND APPARATUS FOR INTERFERENCE-AWARE WIRELESS COMMUNICATIONS

(71) Applicants: Markus Nentwig, Helsinki (FI); Pekka Jänis, Espoo (FI); Cássio Ribeiro, Espoo (FI); Chunyan Gao, Beijing (CN); Haiming Wang, Beijing (CN)

(72) Inventors: Markus Nentwig, Helsinki (FI); Pekka Jänis, Espoo (FI); Cássio Ribeiro, Espoo (FI); Chunyan Gao, Beijing (CN); Haiming Wang, Beijing (CN)

(73) Assignee: NOKIA CORPORATION, Espoo (FI)

(21) Appl. No.: 13/822,046

(22) PCT Filed: Sep. 14, 2010
(86) PCT No.: PCT/CN10/76867

§ 371 Date: Mar. 11, 2013

(51) Int. Cl. H04W 72/12

(52) U.S. Cl. CPC H04W 72/1231
USPC 455/501

(57) ABSTRACT

In accordance with an example embodiment of the present invention, a method comprises receiving at a controlling node an interference measurement report from a first node; determining from a transmission schedule a transmit activity by a second node during an interference measurement period associated with the interference measurement report; estimating a contributing interference from the transmit activity by the second node during the measurement period; and causing an adjustment to the contributing interference.

### TECHNICAL FIELD

The present application relates generally to an apparatus and a method for interference-aware wireless communications.

### BACKGROUND

A wireless system may provide local-area coverage in selected areas and to ensure good coverage, access points (APs) or other network nodes may be deployed densely, with each AP covering a relatively small cell with a small number of users. Such a wireless system may need organize and optimize autonomously, and be tolerant to interferences, such as those resulting from other radio access technologies include wireless local area network (WLAN) operating in the same wireless medium.

The wireless medium may be organized into radio resources such as frequency channels, time slots, subcarrier sets, codewords or any combination thereof. For example, a radio resource may be formed by a predetermined bandwidth. Wireless devices may select radio resources for transmission in such a way that interference to neighboring nodes receiving on the same resource is limited to an acceptable level. Levels of interference to the neighboring nodes need to be carefully managed during the operation of the wireless system and either too much or too little interference may lead to degraded performance. An unacceptably large amount of interferences obviously affect the reception of a neighbor node. On the other hand, too little interference may indicate that the opportunities to reuse a resource by a neighboring node may be wasted. An optimal performance of the radio system is typically achieved at a mid-range level of interference.

### SUMMARY

Various aspects of the invention are set out in the claims.

In accordance with an example embodiment of the present invention, a method comprises receiving at a controlling node an interference measurement report from a first node; determining from a transmission schedule a transmit activity by a second node during an interference measurement period associated with the interference measurement report; estimating a contributing interference from the transmit activity by the second node during the measurement period; and causing an adjustment to the contributing interference.

In accordance with an example embodiment of the present invention, an apparatus comprises at least one processor; and at least one memory including computer program code, the at least one memory and the computer program code configured to, with the at least one processor, cause the apparatus to perform at least the following: receiving an interference measurement report from a first node; determining from a transmission schedule a transmit activity by a second node during an interference measurement period associated with the interference measurement report; estimating a contributing interference from the transmit activity by the second node during the measurement period; and causing an adjustment to the contributing interference.

In accordance with another example embodiment of the present invention, a method comprises measuring at an interfered node an interference on a scheduled basis or on demand during an interference measurement period; determining an interference measurement report based on the measured interference during the interference measurement report period; and transmitting the interference measurement report.

### BRIEF DESCRIPTION OF DRAWINGS

For a more complete understanding of example embodiments of the present invention, reference is now made to the following descriptions taken in connection with the accompanying drawings in which:

FIG. 1 illustrates an example wireless system in accordance with an example embodiment of the invention;

FIG. 2 illustrates an example method for interference-aware wireless communications in accordance with an example embodiment of the invention;

FIG. 3 illustrates an example transmit activity diagram with a transmission schedule in accordance with an example embodiment of the invention;

FIG. 4 illustrates an example wireless system with multiple interference measurement reports in accordance with an example embodiment of the invention;

FIG. 5 illustrates an example method for interference-aware wireless communications at an interfered node in accordance with an example embodiment of the invention; and

FIG. 6 illustrates an example wireless apparatus in accordance with an example embodiment of the invention.

### DETAILED DESCRIPTION

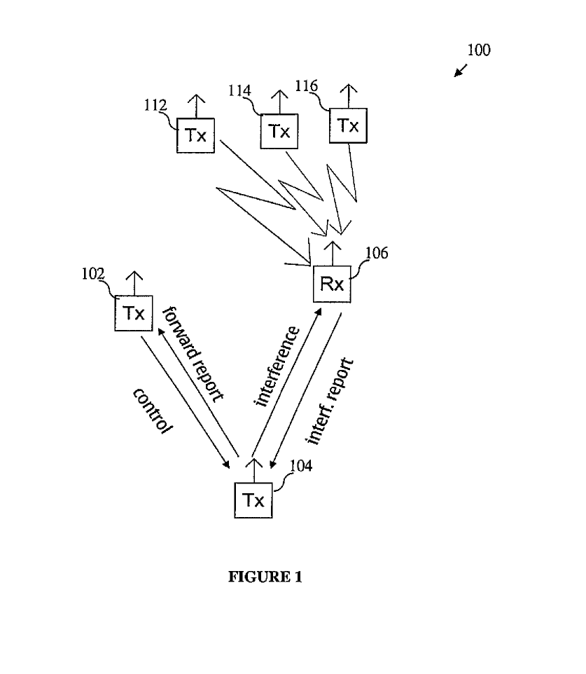

An example embodiment of the present invention and its potential advantages are best understood by referring to FIGS. 1 through 6 of the drawings, like numerals being used for like and corresponding parts of the various drawings.

FIG. 1 illustrates an example wireless system 100 in accordance with an example embodiment of the invention. The wireless system 100 includes a controlling node 102, a controlled node 104, an interfered node 106 and a set of uncontrolled nodes 112 though 116. The controlling node 102 may directly control the controlled node 104 via a control link and the controlled node 104 may directly interfere with the interfered node 106. In addition, the interfered node may also be interfered by the uncontrolled nodes 112 through 116.

In one example embodiment, when a nontrivial change to the configuration of a local wireless network takes place, the change such as addition or removal of a neighbor node, the wireless network 100 may invoke an interference-evaluation and adjustment method to achieve an optimal level of interference. The controlling node 102 may command the controlled node 104 to transmit data to a receiving node. The receiving node may be identical to the controlling node or the receiving node may be a different node, which is not shown. Transmission by the controlled node 104 may create interference to the interfered node 106. At the same time, one or all of the uncontrolled nodes 112 through 116 may also create interference to the interfered node 106. In one example embodiment, the controlling node is identical to the controlled node.

In one example embodiment, the interfered node 106 may measure the interference it receives and send an interference report to the controlled node 104 in a broadcast message. The controlled node 104 may estimate a path loss to the interfered node based on the received broadcast and forward the interference report to the controlling node 102, together with a path loss estimate. The controlling node 102 with an interference management model may determine a contributing interference by the controlled node 104 to the interference report, based on the path loss estimate it received from the controlled node 104 and other data such as a transmit schedule. Based on whether the contributing interference plays a major role in the interference to the interfered node 106, the controlling node 102 may command the controlled node 104 to change transmit activity to cause an adjustment to the contributing interference. For example, if the contributing interference from the controlled node 104 plays a dominant role to the total interference received at the interfered node 106, the controlling node 102 may command the controlled node 104 to reduce its transmit power to lower the level of the interference to the interfered node 106. On the other hand, if the contributing interference caused by the controlled node 104 is insignificant, the controlling node 102 may request the controlled node 104 increase its transmit power to a point where an efficient balance between the interference level and optimal resource utilization is achieved.

In one example embodiment, the wireless network 100 is a wireless local area network (WLAN). In such an example WLAN, the controlling node 102 is an access point, the controlled node 104 is a user equipment, and the interfered node 106 is another user equipment while the uncontrolled nodes 112 through 116 may be a combination of a set of access point and associated user equipments.

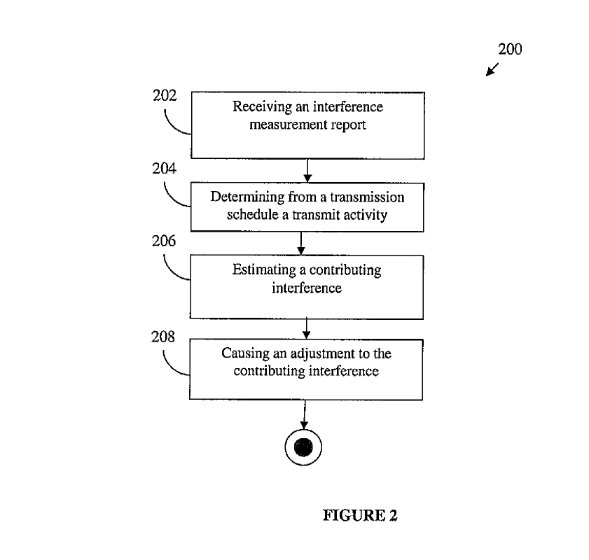

FIG. 2 illustrates an example method 200 for interference-aware wireless communications in accordance with an example embodiment of the invention. The method 200 includes receiving an interference measurement report at block 202 and determining from a transmission schedule a transmit activity at block 204. The method 200 also includes estimating a contributing interference at block 206 and causing an adjustment to the contributing interference at block 208.

In one example embodiment, receiving an interference measurement report at block 202 may include a controlling node receiving an interference measurement report directly from an interfered node or indirectly via a relay node. A controlled node such as the node 104 of FIG. 1 may act as a relay node. In one example embodiment, the controlling node may receive the interference measurement report from the interfered node such as the interfered node 106 of FIG. 1. In one example embodiment, the controlling node may be an access point of a wireless local area network, a user equipment, or a long-term evolution (LTE) node 13 (eNode B). The controlled node may be a user equipment, an access point, or other type of network nodes that may be controlled by the controlling node. The interfered node may be any network node that may share the same radio resource as the controlled node and some uncontrolled nodes and may receive interference from those nodes. The examples of the interfered node may include WLAN user equipment, LTE user equipment, or a WLAN access point.

In one example embodiment, determining from a transmission schedule a transmit activity at block 204 may further comprise determining whether the controlled node is transmitting during the interference measurement period. Determining the transmit activity at block 204 may also include determining a measurement of a transmit energy emitted by the controlled node during the interference measurement period. From the transmit energy, the amount of interference may be determined or estimated. In addition, the controlling node, the controlled node and the interfered node may need to synchronize the interference measurement period to accommodate a dynamic network environment. In one example embodiment, determining the transmit activity at block 204 may also include determining the interference measurement period from an earlier request for the interference measurement report from a controlling node. In this case, the controlling node determines the measurement period and sends the measurement period for the next measurement in a measurement report request. This may give the controlling node the flexibility to get an interference measurement report on demand as a need arises. The measurement report period may be marked by two time offsets t₁ and t₂. The first time offset t₁ may mark a start of the interference measurement period and the second time offset t₂ the end of the interference measurement period based on either predetermined constants or values encoded in the interference measurement report that the controlled node sends to the controlling node.

In one example embodiment, estimating a contributing interference at block 206 may include estimating a path loss to the interfered node on a radio resource shared between the controlled node and the interfered node. This may include measuring a received signal strength of a report message and comparing the received signal strength to a known transmit signal strength of the report message. Estimating the contributing interference at block 206 may also include estimating an average transmit power of the controlled node during the interference measurement period by summing up a product of a transmit time and a transmit power. In one example embodiment, estimating the contributing interference at block 206 may also include obtaining a remaining interference by subtracting the contributing interference caused by the controlled node from the interference measurement report. The remaining interference may be considered a prediction of noise plus interference at a neighbour node, if the controlled node does not transmit. This may enable the controlling node to determine whether the contributing interference by the controlled node is significant in the overall interferences received by the interfered node.

In one example embodiment, causing an adjustment to the contributing interference at block 208 may include the controlling node taking action according to the results of estimating the contributing interference, to achieve an optimal level of interference so that the resource utilization is maximized while an acceptable level of interference is not exceeded. If it is determined that the contributing interference by the controlled node is a main contributor to the overall interference received by the interfered node, the controlling node may cause the controlled node to perform one or more of the following actions. The controlling node may have the controlled node select a transmit power that does not exceed a maximum level of interference at the interfered node, or prevent a transmission from the controlled node on a resource that is reserved for the interfered node. A reserved resource may be identified by the reception of a signal or message indicating reservation of the resource. The reservation of a resource may be indicated by an interference report, a request-to-send (RTS) message, a clear-to-send (CTS) message, a data-sending message (DS) or other types of messages. The reservation of a resource may be communicated to a node through other means, such as a configuration file, or a query from a spectrum management database. The controlling node may also determine a maximum transmit power by determining a maximum tolerable level of interference at the interfered node and scaling it with the estimated path loss. The controlling node may also cause the controlled node to choose a transmit power not exceeding the maximum transmit power and configure the transmissions by the controlled node based on the chosen transmit power. In one example embodiment, the maximum tolerable level of interference is equal to a noise and interference at the interfered node, excluding the contributed interference by the controlled node.

In one example embodiment, if the contributing interference by the controlled node is an insignificant contributor to the overall interference received at the interfered node, the controlling node may take different actions. For example, causing the adjustment to the contributing interference at block 208 may include causing the controlled node to increase the transmit power to better utilize the allocated radio resource.

In one example embodiment, causing the adjustment to the contributing interference at block 208 may also include choosing a transmit power based on a utility function that depends on interferences generated at several interfered nodes, and their respective background interference levels. In some cases, there are multiple controlled nodes that interfere with the interfered node and thus making an adjustment to the contributing interference may take into consideration all contributing interferences. Causing the adjustment to the contributing interference at block 208 may also include causing the controlled node to adjust its transmission power upward or downward to reach an optimal trade-off between a gained throughput and a lost throughput that may be expressed with a utility function for both downlink and uplink resources. The utility function may be a function of signal-to-interference-and-noise ratio (SINR) of a radio link. The utility function may utilize Shannon's capacity equation

$$C \text{∼} {log}_{2} ( 1 + \frac{S}{N + I} ) ,$$

wherein C is a capacity in bits per second, S is an equivalent signal power on a resource, N is an equivalent noise power on the resource, and I is an interference power on a resource. The utility function may impose constraints on the SINR, for example by limiting the SINR to not exceeding a predetermined threshold. The gained throughput may be determined as a change in capacity of a link related to the controlled node, and the lost throughput may be determined as a change in capacity of a link related to the interfered node.

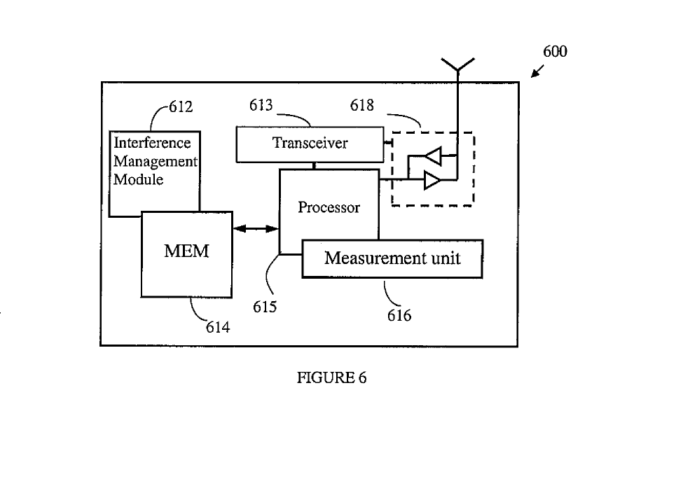

In one example embodiment, the method 200 may be implemented at the controlling node 102 of FIG. 1 or by the apparatus 600 of FIG. 6. In one embodiment, the controlling node and the controlled node may be the same node. The method 200 is for illustration only and the steps of the method 200 may be combined, divided, or executed in a different order than illustrated, without departing from the scope of the invention of this example embodiment.

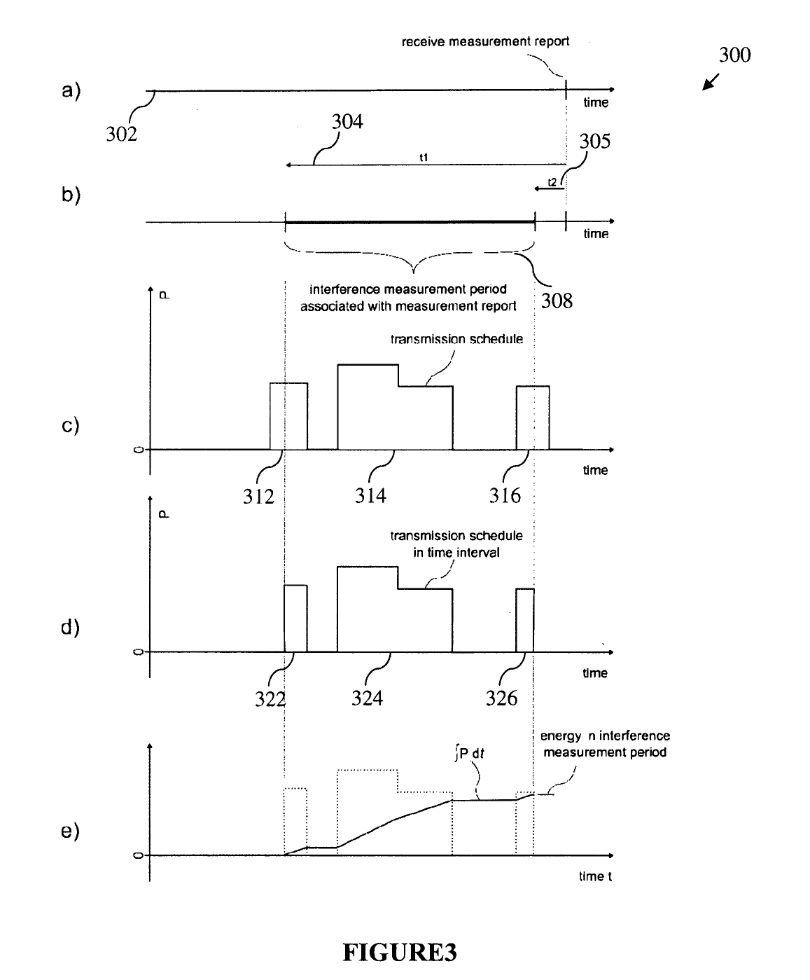

FIG. 3 illustrates an example transmit activity diagram 300 with a transmission schedule in accordance with an example embodiment of the invention. The transmit activity diagram 300 illustrates the transmit activity via parts a) through e). In one example embodiment, the part a) shows that the controlling node receives an interference measurement report at the end of the time period 302, the interference measurement report that may be related to a radio resource.

In one example embodiment, the part b) of the diagram 300 shows that the controlling node may determine the interference measurement period associated with the interference measurement and measurement report based on two time offsets, the first offset t₁ 304 and the second time offset t₂ 305. The first time offset t₁ covers a time period from beginning of the interference measurement to the receiving of the interference measurement report by the controlling node. The time offset t₂ covers a time period from the point when the interference measurement is completed to the point when the interference measurement report is sent to the controlling node. Thus the interference measurement period 308 is a difference between the time offset t₁ and the time offset t₂. The time offsets t₁ and t₂ may be predetermined constants or may be encoded into the interference measurement report. The measurement report period may be associated with an earlier request for a measurement report by the controlling node or may be configured by the controlling node.

In one example embodiment, part c) of the diagram 300 illustrates a history of transmit activity by the controlled node. The transmit activity may indicate a transmit power P emitted by the controlled node over a time period on a radio resource. In one example embodiment, part d) of the diagram 300 illustrates a determined transmit activity during the determined measurement period. The interference measurement period covers the entire transmission schedule 314 and partial transmission schedules 312 and 316. The part d) shows only the covered portions of the transmission schedules 312 through 316. The part e) of the diagram 300 illustrates the estimation of transmission energy of the controlled node, performed by the controlling node. The controlling node may perform the estimation of transmission energy and scale it with a path loss estimate provided by the controlled node for the purpose of determining the amount of interference contributed by the controlled node to the interfered node.

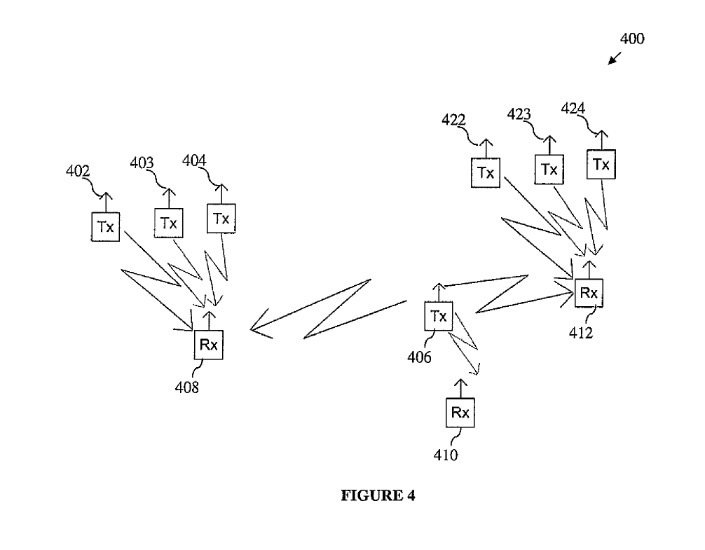

FIG. 4 illustrates an example wireless system 400 with multiple interference measurement reports in accordance with an example embodiment of the invention. The example wireless system 400 includes a node 406 and three interfered nodes 408, 410 and 412. The node 406 may act as both a controlled node and a controlling node, in control of its own transmissions. The interfered nodes are interfered by different sets of nodes. For example, the interfered node 408 may be interfered by the uncontrolled nodes 402 through 404 and the node 406; the interfered node 410 may be interfered by the node 406; and the interfered node 412 may be interfered by the uncontrolled nodes 422 through 424 in addition to the node 406. The node 406 may choose a transmit power based on a utility function that depends on interference generated at multiple_interfered nodes such as nodes 408 though 412, and their respective background interference levels. In an example embodiment, the node 406 may receive multiple interference measurement reports. For each interference measurement report provided by an interfered node, the node 406 may determine a transmit activity related to the interfered node during an interference measurement period associated with the interference measurement report. The node 406 may estimate a contributing interference to each interfered node from the determined transmit activity related to the interfered node and a path loss estimate to the interfered node. Causing an adjustment to the contributing interference may be performed based on each individual interference measurement report. The node 406 may control its transmissions to maximize a utility function that depends on the throughput gained at the node 406, and the throughput lost at the nodes 408 through 412.

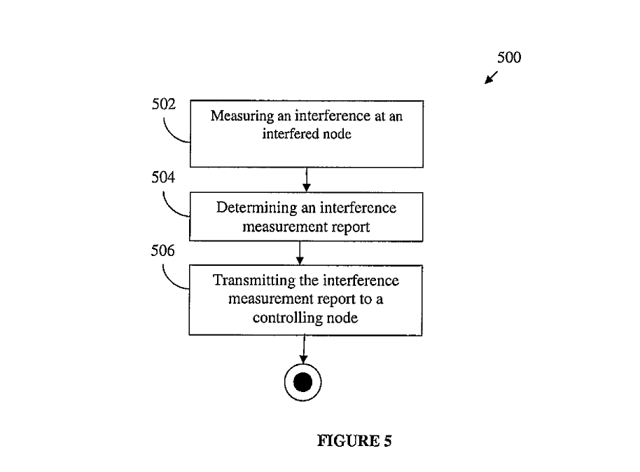

FIG. 5 illustrates an example method 500 for interference-aware wireless communications at an interfered node in accordance with an example embodiment of the invention. The method 500 includes measuring at an interfered node an interference to an interfered node at block 502, determining an interference measurement report at block 504 and transmitting the interference measurement report at block 506.

In one example embodiment, measuring at the interfered node the interference to the interfered node at block 502 may include measuring the interference to the interfered node on a scheduled basis or on demand during an interference measurement period that is marked by a first time offset t₁ at the beginning of the interference measurement period and by a second time offset t₂ at the end of the interference measurement period. In one example embodiment, the method 500 may include providing means for a controlled node to estimate a path loss. This may be accomplished via encoding into the interference measurement report a signal feature with a predetermined power, a transmit power, or a path loss estimation message, or via transmitting a reference or pilot signal to the controlled node.

In one example embodiment, determining an interference measurement report at block 504 may include determining a transmit power of a path loss estimation message, the transmit power that may be encoded, predetermined or requested by the controlling node. In one example embodiment, transmitting the interference measurement report to a controlling node at block 506 may include transmitting the interference measurement report via a broadcast message. In one example embodiment, the interference measurement report is received by more than one controlling node. The interference measurement period may be relative to a predetermined time interval associated with the first time offset t₁ and the second time offset t₂. The interference measurement report may include other information such as the interference measurement period, the first time offset t₁ and the second time offset t₂, among others. The interference measurement report may be transmitted directly to the controlling node or via a relay node. In one embodiment, transmitting the interference measurement report at block 506 may include transmitting the interference measurement report together with the interference measurement period either directly to the controlling node or via a relay node.

In one example embodiment, the method 500 may be implemented at an interfered node, for example, the node 106 of FIG. 1. The method 500 is for illustration only and the steps of the method 500 may be combined, divided, or executed in a different order than illustrated, without departing from the scope of the invention of this example embodiment.

FIG. 6 illustrates an example wireless apparatus in accordance with an example embodiment of the invention. In FIG. 6, the wireless apparatus 600 may include a processor 615, a memory 614 coupled to the processor 615, and a suitable transceiver 613 (having a transmitter (TX) and a receiver (RX)) coupled to the processor 615, coupled to an antenna unit 618. The memory 614 may store programs such as an interference management module 612. The wireless apparatus 600 may be at least part of a generic 4^{th} generation base station, or an LTE compatible base station.

The processor 615 or some other form of generic central processing unit (CPU) or special-purpose processor such as digital signal processor (DSP), may operate to control the various components of the wireless apparatus 600 in accordance with embedded software or firmware stored in memory 614 or stored in memory contained within the processor 615 itself. In addition to the embedded software or firmware, the processor 615 may execute other applications or application modules stored in the memory 614 or made available via wireless network communications. The application software may comprise a compiled set of machine-readable instructions that configures the processor 615 to provide the desired functionality, or the application software may be high-level software instructions to be processed by an interpreter or compiler to indirectly configure the processor 615.

In an example embodiment, the interference management module 612 at a controlling node may be configured to receive an interference measurement report from a controlled node and to determine from a transmission schedule a transmit activity by a second node during an interference measurement period associated with the interference measurement report. The interference management module 612 at the controlling node may be configured to estimate a contributing interference from the transmit activity by the second node during the measurement period and to cause an adjustment to the contributing interference to achieve a better resource utilization while keeping the interference to the interfered node to an acceptable level.

In one example embodiment, the transceiver 613 is for bidirectional wireless communications with another wireless device. The transceiver 613 may provide frequency shifting, converting received RF signals to baseband and converting baseband transmit signals to RF, for example. In some descriptions a radio transceiver or RF transceiver may be understood to include other signal processing functionality such as modulation/demodulation, coding/decoding, interleaving/deinterleaving, spreading/despreading, inverse fast fourier transforming (IFFT)/fast fourier transforming (FFT), cyclic prefix appending/removal, and other signal processing functions. In some embodiments, the transceiver 613, portions of the antenna unit 618, and an analog baseband processing unit may be combined in one or more processing units and/or application specific integrated circuits (ASICs). Parts of the transceiver may be implemented in a field-programmable gate array (FPGA) or reprogrammable software-defined radio.

In an example embodiment, the antenna unit 618 may be provided to convert between wireless signals and electrical signals, enabling the wireless apparatus 600 to send and receive information from a cellular network or some other available wireless communications network or from a peer wireless device. In an embodiment, the antenna unit 618 may include multiple antennas to support beam forming and/or multiple input multiple output (MIMO) operations. As is known to those skilled in the art, MIMO operations may provide spatial diversity and multiple parallel channels which can be used to overcome difficult channel conditions and/or increase channel throughput. The antenna unit 618 may include antenna tuning and/or impedance matching components, RF power amplifiers, and/or low noise amplifiers.

As shown in FIG. 6, the wireless apparatus 600 may further include a measurement unit 616, which measures the signal strength level that is received from another wireless device, and compare the measurements with a configured threshold. The measurement unit may be utilized by the wireless apparatus 600 in conjunction with various exemplary embodiments of the invention, as described herein.

In general, the various exemplary embodiments of the wireless apparatus 600 may include, but are not limited to, part of a base station, an access point or a wireless device such as a portable computer having wireless communication capabilities, Internet appliances permitting wireless Internet access and browsing, as well as portable units or terminals that incorporate combinations of such functions. In one embodiment, the wireless apparatus 600 may be implemented in the network node 102 of FIG. 1.

Without in any way limiting the scope, interpretation, or application of the claims appearing below, a technical effect of one or more of the example embodiments disclosed herein is to remove the influence of past transmit activity to reported noise levels from other nodes. Another technical effect is to detect more opportunities for reusing radio resources without causing unacceptable levels of interference, leading to more efficient transmission.

Embodiments of the present invention may be implemented in software, hardware, application logic or a combination of software, hardware and application logic. The software, application logic and/or hardware may reside on a base station, an access point, a user equipment or similar network device. If desired, part of the software, application logic and/or hardware may reside on an access point, and part of the software, application logic and/or hardware may reside on a network element such as a base station. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 6. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1.-36. (canceled)

37. a method, comprising:
receiving, at a controlling node, an interference measurement report from a first node;
determining, from a transmission schedule, a transmit activity by a second node during an interference measurement period associated with the interference measurement report;
estimating a contributing interference from the transmit activity by the second node during the measurement period; and
causing an adjustment to the contributing interference.

38. The method of claim 37, wherein the determining the transmit activity further comprises determining whether the second node is transmitting during the interference measurement period.

39. The method of claim 37, wherein the determining the transmit activity further comprises determining a transmit energy emitted by the second node during the interference measurement period.

40. The method of claim 37, wherein the determining the transmit activity further comprises determining the interference measurement period from an earlier request for the interference measurement report or based on a first time offset t₁ and a second time offset t₂, relative to a time when the interference measurement report is received.

41. The method of claim 37, wherein the estimating the contributing interference comprises estimating a path loss to the first node on a radio resource by measuring a received signal strength of a report message, and comparing the received signal strength to a known transmit signal strength of the report message.

42. The method of claim 37, further comprising:
determining, from a plurality of transmission schedules, a plurality of transmit activities by a plurality of controlled nodes;
estimating the contributing interference from each of the plurality of the transmit activities; and
causing an adjustment to the contributing interference based on each of the plurality of transmit activities.

43. The method of claim 42, wherein the estimating the contributing interference comprises obtaining a remaining interference by subtracting contributing interference caused by each of the plurality of the controlled nodes from the interference measurement report.

44. The method of claim 37, wherein the causing the adjustment to the contributing interference further comprises performing, upon determining that the contributing interference is a main contributor to the interference measurement report, at least one of:
selecting a transmit power that does not exceed a maximum level of interference at the first node; and
preventing a transmission from the second node on a resource reserved for the first node.

45. The method of claim 37, wherein the causing the adjustment to the contributing interference further comprises performing at least one of:
determining a maximum tolerable level of interference;
determining a maximum transmit power by scaling the maximum tolerable level of interference with a path loss estimate;
choosing a second transmit power not exceeding the maximum transmit power; and
configuring transmissions of the second node based on the chosen second transmit power.

46. The method of claim 45, wherein the causing the adjustment to the contributing interference further comprises choosing a transmit power based on a utility function that depends on an interference generated at multiple interfered nodes, and their respective background interference levels.

47. The method of claim 45, wherein the causing the adjustment to the contributing interference further comprises causing the second node to adjust its transmission power to reach an optimal trade-off between a gained throughput and a lost throughput using a utility function for downlink and uplink resources.

48. The method of claim 37, wherein the estimating the contributing interference comprises obtaining a remaining interference by subtracting the contributing interference caused by the second node from the interference measurement report.

49. The method of claim 37, wherein the second node and the controlling node are same node.

50. An apparatus, comprising:
at least one processor; and
at least one memory including computer program code,
the at least one memory and the computer program code configured to, with the at least one processor, cause the apparatus to perform, at least, receiving an interference measurement report from a first node;
determining from a transmission schedule a transmit activity by a second node during an interference measurement period associated with the interference measurement report;
estimating a contributing interference from the transmit activity by the second node during the measurement period; and
causing an adjustment to the contributing interference.

51. The apparatus of claim 50, wherein the apparatus is a controlling node and comprises one of an access point, a user equipment and a LTE eNode B, wherein the second node is a controlled node and comprises one of a user equipment, an access point and a fourth generation mobile station, and wherein the first node is an interfered node and comprises one of an access point and a user equipment.

52. The apparatus of claim 50, wherein the transmission schedule comprises at least one of
an instruction from the apparatus to the second node to indicate when to transmit data, on what resource and at what time interval to transmit the data for an uplink transmission;
a record including a permission from the apparatus to the second node for a transmission of data and an time interval associated with transmission; and
a record including a grant for a frequency resource, a time period for a device-to-device (D2D) pair or cluster including the second node, and a transmission grant and a resource allocation instruction on how to allocate resource among the D2D pair or cluster.

53. The apparatus of claim 50, wherein the interference measurement period is determined from an earlier request for the interference measurement report.

54. The apparatus of claim 50, wherein the interference measurement period is marked by two time offsets t₁, and t₂ with the first time offset t₁ marking a start of the interference measurement period and the second time offset t₂ marking an end of the interference measurement period based on either predetermined constants or values encoded in the interference measurement report.

55. The apparatus of claim 50, wherein the transmission schedule comprises one of
a one-bit binary value to indicate whether the second node contributed to the contributing interference; and
a continuous or quantized value indicating an amount of the contributing interference of the second node.

56. A program storage device readable by a machine, tangibly embodying a program of instructions executable by the machine for performing operations, said operations comprising:
receiving, at a controlling node, an interference measurement report from a first node;
determining from a transmission schedule a transmit activity by a second node during an interference measurement period associated with the interference measurement report;
estimating a contributing interference from the transmit activity by the second node during the measurement period; and
causing an adjustment to the contributing interference.
